(19) United States
(12) Patent Application Publication
(10) Pub. No.: US 2005/0004283 A1
(43) Pub. Date: Jan. 6, 2005

(54) (Meth)acrylate resins and their use

(76) Inventor: Jutta Lindemann, Ehrenburg (DE)

Correspondence Address: SQUIRE, SANDERS & DEMPSEY L.L.P.;Two Renaissance Square, Suite 2700, 40 North Central Avenue, Phoenix, AZ, 85004-4498, US

(21) Appl. No.: 10/825,725

(22) Filed: Apr. 15, 2004

(30) Foreign Application Priority Data
Apr. 15, 2003 (DE) 10318443.0

(51) Int. Cl. C08L 1/00

(52) U.S. Cl. 524/128; 525/387; 524/556

(57) ABSTRACT

The present invention relates to a (meth)acrylate resin comprising: 20-85% by weight (meth)acrylate, 10-40% by weight of a polymer soluble in (meth)acrylate, 0.1-2% by weight paraffin, 0-50% by weight hydroxy(meth)acrylate, and 0.1-2% by weight adhesion promoter; and the use of a (meth)acrylate resin in accordance with the present invention to repair and/or seal pipes, especially sewer pipes.

### RELATED APPLICATION

This application claims priority to Germany Application Serial No. 10318443.0, filed Apr. 15, 2003.

### FIELD OF THE INVENTION

The present invention relates to (meth)acrylate resins and their use.

### BACKGROUND OF THE INVENTION

Numerous (meth)acrylate resins are known from the state of the art, which comprise a wide variety of compositions to make them suitable for the most varied fields of application. Appropriate additives to the (meth)acrylate resins, such as cross-linking agents, paraffins, stabilisers or the like, can create a purposive improvement in the characteristics of the (meth)acrylate resin.

By way of example, (meth)acrylate resins can be used as moulded bodies, in combination with glass fibres to maintain excellent mechanical strengths, for works of art, for incorporations, as adhesives, as coating compounds or even as wood impregnation products, see Kunststoffhandbuch, Volume IX, Polymethacrylate, Carl Hanser Verlag, Munich 1975.

One important area of use for (meth)acrylate resins is the field of repairing and/or sealing pipes, especially sewer pipes. Pipes of this kind, most of which are laid subterraneously, can offer suffer damage, which makes it necessary to repair or seal them in order to avoid replacing the defective pipe completely. These pipes are often made from stoneware, concrete or plastic, such as PVC.

In order to repair or seal these pipes, a “packer” is introduced into the pipe. This packer is basically a rubber bellows covered with a stretch film, into which compressed air can be admitted, thus making it expandable so that it can be adapted completely to the diameter of the pipe to be repaired. Before the packer is introduced into the pipe to be repaired, it is equipped with a mat, especially a glass fibre mat, impregnated with the (meth)acrylate resin, the rubber bellows before introduction still being smaller in diameter relative to the diameter of the pipe to be repaired. The packer is then introduced, with this smaller diameter, into the pipe or advanced therein and is inflated with compressed air at the location to be repaired, so that it expands and urges the mat impregnated with the (meth)acrylate resin against the area of the pipe to be repaired. The area to be repaired here can be of dimensions ranging in length from less than 1 m to as much as 5 m. These mats remain urged by the rubber bellows against the inner wall the pipe to be repaired until the (meth)acrylate resin is cured. Then the compressed air is released from the rubber bellows, so that its diameter is reduced, and the packer is removed from the pipe again.

The (meth)acrylate resins used thus far for repairing or sealing pipes in this way exhibited unsatisfactory adhesion to the inside of the pipe, in both dry and moist pipes. Nor were they satisfactorily leak-proof as a rule, especially in the case of seals against pressing water.

In addition to using (meth)acrylate resins for sealing pipes, sodium silicate, epoxy and polycarbamide systems are also known in the state of the art. Not only can all three prior-art systems only be used within a limited temperature range, but polycarbamide systems in particular are expensive, and epoxy resin systems must be classified as harmful to the health. Moreover, these three systems require unsatisfactory, long curing times, which delays further processing, such as milling out branch connection points within the repaired areas of the pipe.

### SUMMARY OF THE INVENTION

The present invention is thus based on the problem of providing a (meth)acrylate resin that overcomes the disadvantages of the state of the art and which can be advantageously used in repairing or sealing pipes.

The problem is solved by a (meth)acrylate resin preferably comprising: 20-85% by weight (meth)acrylate, 10-40% by weight of a polymer soluble in (meth)acrylate, 0.1-2% by weight paraffin, 0-50% by weight hydroxy(meth)acrylate, and 0.1-2% by weight adhesion promoter.

In addition, the invention preferably comprises a (meth)acrylate resin comprising: 30-40% by weight (meth)acrylate, 25-35% by weight of a polymer soluble in (meth)acrylate, 0.5-1% by weight paraffin, 5-40% by weight hydroxy(meth)acrylate, 0.2-1.0% by weight adhesion promoter.

The (meth)acrylate is preferably methyl methacrylate.

It is preferably further provided that the polymer comprises a (meth)acrylate homopolymer and/or a copolymer.

In addition, the invention preferably provides that the homopolymer is polymethyl methacrylate.

In addition, it can be provided that the copolymer is a copolymer of methyl methacrylate and butyl methacrylate, methyl methacrylate and ethyl acrylate or vinyl chloride and vinyl acetate.

In addition, it is preferred that the hydroxy(meth)acrylate is hydroxyethyl methacrylate.

It can further be provided that the (meth)acrylate resin contains 1-10% by weight cross-linking agent, preferably 1-3% by weight.

Furthermore, it can preferably be provided that the cross-linking agent is ethylene glycol dimethacrylate, 1,4 butanediol dimethacrylate and/or tri-ethylene glycol dimethacrylate.

An advantageous embodiment of the invention provides that the (meth)acrylate resin comprises 0.1 to 2% by weight defoamer, preferably 0.1-1.0% by weight (based on the (meth)acrylate resin).

It is also preferred that the (meth)acrylate resin comprises further conventional additives, such as 0.1-2% by weight co-stabiliser and/or 0.01-0.1% by weight stabiliser.

It is preferred that the (meth)acrylate resin comprises 0.02 to 0.07% by weight stabiliser and/or 0.5-1.0% by weight co-stabiliser.

It can also be provided that the stabiliser is 2,6 di-tert. butyl-4-methyl phenol and the co-stabiliser is tri-(2,4 di-tert. butyl phenyl)phosphite.

The invention preferably provides that the (meth)acrylate resin comprises 0.1-1.5% by weight, preferably 0.4-0.8% by weight, accelerator and 0.1-5% by weight, preferably 2-4% by weight initiator.

In yet another embodiment of the invention, it can be provided that the accelerator is methyl hydroxyethyl paratoluidine, dimethyl paratoluidine, dihydroxyethyl paratoluidine or dihydroxypropyl paratoluidine and/or that the initiator is benzoyl peroxide.

It is also preferred that the paraffin should comprise a mixture of different paraffins with different softening points, especially paraffins with a softening point between 46 and 48° C., paraffins with a softening point between 52 and 54° C. and paraffins with a softening point between 63 and 66° C.

The problem is further solved by the fact that the adhesion promoter is a phosphoric ester, especially methacryloyl oxyethyl phosphate.

It is provided, in accordance with the invention, that the viscosity of the (meth)acrylate resin before curing is at least 250 mPa/s at D=1,000 l/s or at least 300 mPa/s at D=100 l/s.

It is preferable that a colorant, such as colour pigments or a dye paste, should also be added to the acrylate resin.

In addition, the (meth)acrylate resin of the invention can be used to repair and/or seal pipes, especially sewer pipes.

It is preferable that it should be used in pipes produced from stoneware, concrete or plastic, such as polyvinyl chloride.

### DETAILED DESCRIPTION OF PREFERRED EMBODIMENTS

A description of a preferred embodiment shall now be made, it being understood that this description is made solely for the purpose of illustration and not to limit the scope of the invention. The invention is based on the surprising finding that, by using the (meth)acrylate resin of the invention, repairs and/or seals, especially with pipes, can be carried out quickly and simply.

The use of the (meth)acrylate resin of the invention provides an extremely rapid curing time, its use is possible substantially regardless of the temperature, and the (meth)acrylate resin used is physiologically harmless. In addition, the (meth)acrylate resin of the invention exhibits viscosities which ensure that the (meth)acrylate resin is not too liquid during transport of the resin or of the mat impregnated with the resin, which would allow it to drip off, and also that it is not too viscous, so that substantially complete wetting and impregnation of the glass fibre mat is possible and the inclusion of air is avoided.

It is preferred to use the adhesion promoter and the (meth)acrylate-soluble polymer in the quantities specified, since, in combination, they essentially ensure that a (meth)acrylate resin is obtained which is appropriate for the intended use. However, the invention is not limited to these precise quantities. The (meth)acrylate used in the (meth)acrylate resin is advantageously hydrophilised by hydroxy(meth)acrylate. Moreover, when the (meth)acrylate resin of the invention is used, the acid number is adjusted within a desired range. The addition of the defoamer to the (meth)acrylate resin of the invention helps to ensure that this resin is also suitable for use in repairing and/or sealing pipes against pressing water.

The term “(meth)acrylate”, as used herein, comprises all acrylate and methacrylate resins. The use of (meth)acrylate resins of the invention is not limited to repairing and/or sealing pipes.

Other features and advantages of the present invention will be explained and illustrated in the following with reference to three examples, which are not, however, intended to limit the scope of protection in any way. Where not specified otherwise, all % by weight figures are based on the (meth)acrylate resin.

### EXAMPLE 1

5 kg (meth)acrylate resin were prepared by mixing the following components: 32.04% by weight methyl methacrylate, 33.00% by weight copolymer of methyl methacrylate and butyl methacrylate (Acryperl 200, obtainable from Cray Valley; Acryperl 200 is a copolymer of 66% butyl methacrylate, 33% methyl methacrylate and 1% methacrylic acid with a molecular weight of 55,000), 2.00% by weight ethylene glycol dimethacrylate, 0.80% by weight methyl hydroxyethyl paratoluidine, 0.30% by weight paraffin (softening point 46 to 480 C), 0.30% by weight paraffin (softening point 52 to 54° C.), 0.20% by weight paraffin (softening point 63 to 66° C.), 0.50% by weight co-stabiliser (Alkanox 240, obtainable from Great Lakes; Alkanox 240 is tri-(2,4 di-tert. butyl phenyl) phosphite), 0.06% by weight 2,6 di-tert. butyl-4-methyl phenol, 30.00% by weight hydroxyethyl methacrylate, 0.30% by weight methacryloyl oxyethyl phosphate and 0.50% by weight defoamer (BYK 052, obtainable from BYK).

The viscosity of the acrylate resin was 285 mPa/s at D=1,000 l/s and 340 mPa/s at D=100 l/s.

The viscosities of the (meth)acrylate resins produced in the examples were determined in a plate/plate rotation viscometer, by plotting a flow curve at a temperature of 25° C. and reading off the relevant values at a shear rate of 1,000 and 100.

### EXAMPLE 2

5 kg (meth)acrylate resin were prepared by mixing the following components: 39.04% by weight methyl methacrylate, 26.00% by weight copolymer of methyl methacrylate and ethyl acrylate (Diakon LG156, obtainable from Lucite; Diakon LG156 is a copolymer of 88% methyl methacrylate and 12% ethyl acrylate with a molecular weight of 80,000), 2.00% by weight ethylene glycol dimethacrylate, 0.80% by weight methyl hydroxyethyl paratoluidine, 0.30% by weight paraffin (softening point 46 to 48° C.), 0.30% by weight paraffin (softening point 52 to 54° C.), 0.20% by weight paraffin (softening point 63 to 66° C.), 0.50% by weight co-stabiliser (Alkanox 240), 0.06% by weight 2,6 di-tert. butyl-4-methyl phenol, 30.00% by weight hydroxyethyl methacrylate, 0.30% by weight methacryloyl oxyethyl phosphate and 0.50% by weight defoamer (BYK 052, obtainable from BYK).

The viscosity of this acrylate resin was greater than 1,000 mPa/s at D=1,000 l/s and 844 mPa/s at D=100 l/s.

### EXAMPLE 3

5 kg (meth)acrylate resin were prepared by mixing the following components: 32.47% by weight methyl methacrylate, 33.00% by weight copolymer of methyl methacrylate and butyl methacrylate (Acryperl 200, obtainable from Cray Valley), 2.00% by weight ethylene glycol dimethacrylate, 0.40% by weight methyl hydroxyethyl paratoluidine, 0.30% by weight paraffin (softening point 46 to 48° C.), 0.30% by weight paraffin (softening point 52 to 54° C.), 0.20% by weight paraffin (softening point 63 to 66° C.), 0.50% by weight co-stabiliser (Alkanox 240), 0.03% by weight 2,6 di-tert. butyl-4-methyl phenol, 30.00% by weight hydroxyethyl methacrylate, 0.30% by weight methacryloyl oxyethyl phosphate and 0.50% by weight defoamer (BYK 052, obtainable from BYK).

The viscosity of this acrylate resin was 344 mPa/s at D=1,000 l/s and 358 mPa/s at D=100 l/s.

### EXAMPLE 4

5 kg (meth)acrylate resin were prepared by mixing the following components: 39.57% by weight methyl methacrylate, 26.00% by weight copolymer of methyl methacrylate and ethyl acrylate (Diakon LG 156), 2.00% by weight ethylene glycol dimethacrylate, 0.80% by weight methyl hydroxyethyl paratoluidine, 0.30% by weight paraffin (softening point 46-48° C.), 0.30% by weight paraffin (softening point 52-54° C.), 0.20% by weight paraffin (softening point 63-66° C.), 0.50% by weight co-stabiliser (Alkanox 240), 0.03% by weight 2,6 di-tert. butyl-4-methyl phenol, 30.00% by weight hydroxyethyl methacrylate and 0.30% by weight methacryloyl oxyethyl phosphate.

### EXAMPLE 5

5 kg (meth)acrylate resin were prepared by mixing the following components: 62.98% by weight methyl methacrylate, 32.69% by weight copolymer of methyl methacrylate and butyl methacrylate (Acryperl 200), 2.00% by weight ethylene glycol dimethacrylate, 1.00% by weight methyl hydroxyethyl paratoluidine, 0.20% by weight paraffin (softening point 46-48° C.), 0.30% by weight paraffin (softening point 52-54° C.), 0.30% by weight paraffin (softening point 63-66° C.), 0.50% by weight co-stabiliser (Alkanox 240), 0.03% by weight 2,6 di-tert. butyl-4-methyl phenol, 0.30% by weight methacryloyl oxyethyl phosphate and 0.50% by weight defoamer (BYK 052).

### COMPARATIVE EXAMPLE 6

5 kg (meth)acrylic resin were prepared by mixing the following components: 62.98% by weight methyl methacrylate, 32.69% by weight copolymer of methyl methacrylate and butyl methacrylate (Acryperl 200), 2.00% by weight ethylene glycol dimethacrylate, 1.00% by weight methyl hydroxyethyl paratoluidine, 0.20% by weight paraffin (softening point 46-48° C.), 0.30% by weight paraffin (softening point 52-54° C.), 0.30% by weight paraffin (softening point 63-66° C.), 0.50% by weight co-stabiliser (Alkanox 240), 0.03% by weight 2,6 di-tert. butyl-4-methyl phenol.

The six (meth)acrylate resins described in Examples 1 to 6 above were used to repair and/or seal sewer pipes and were each mixed with about 3% by weight benzoyl peroxide. It is obvious to a person of skill in this field that any other initiator can also be used for curing. Furthermore, it is readily apparent to a skilled person that the (meth)acrylate resin of the invention can also be cured thermally or by ultraviolet radiation or in any other possible manner,

For each (meth)acrylate resin of Examples 1 to 6, two glazed, dry stoneware pipes with a diameter of 20 cm were placed end to end so that they could be joined with a mat impregnated with the (meth)acrylate resin of the invention. A glass fibre mat impregnated with the respective (meth)acrylate resin was laid around a packer, and the packer was then introduced into the stoneware pipes in order to seal the junction between the two pipes.

The temperature during curing inside the stoneware pipes was 8° C. The curing time in the pipe was about 45 minutes for Examples 1 and 2, after which the (meth)acrylate resin was completely free of tackiness. After 55 minutes curing time, the (meth)acrylate resin of Example 3 was still slightly tacky on its surface.

The sealed stoneware pipes were then subjected to a leak test according to DIN EN 1610. For this purpose, the sealed stoneware pipes were filled with compressed air (initial pressure 200 mbar); according to DIN EN 1610, the pressure loss inside a pipe (sealed at the pipe ends) may not exceed a maximum of 15 mbar within 1.5 minutes, pressure losses of <10 mbar being described as particularly good results.

The results of the pressure losses found for Examples 1 to 6 are shown in the following table.

TABLE 1

Pressure loss [mbar]

| Example | in dry pipe | in wet pipe |
|---|---|---|
| 1 | 3.7 | — |
| 2 | 0.4 | 0.0 |
| 3 | 0.6 | — |
| 4 | 0.5 | — |
| 5 | 0.5 | — |
| 6 | 27.5 | — |
| (comparison) | | |

* The pipe of Example 2 was sprayed with an aqueous soap solution, using a flower spray, before the packer was inserted. The mat was applied directly onto the wet surface.

As is impressively demonstrated by the table, very good seals can be created with the (meth)acrylate resin of the invention, since they lie well below the maximum pressure losses permitted by the test standard. The (meth)acrylate resin of Example 2 achieved the best results here.

As is particularly clear from Example 5, a suitable (meth)acrylate resin can also be obtained if, for use in a dry pipe, no hydroxy(meth)acrylate is used. In contrast to this, a (meth)acrylate resin according to Comparative Example 6, which does not contain any hydroxy(meth)acrylate, defoamer and adhesion promoter, produces pressure losses which do not lead to a suitable seal that satisfies the requirements of DIN EN 1610.

(Meth)acrylate resins according to the present invention can also be used to seal and/or repair pipes or the like against pressing water, as is illustrated by the following examples.

### EXAMPLE 7

5 kg (meth)acrylate resin were prepared by mixing the following components: 32.14% by weight methyl methacrylate, 33.00% by weight copolymer of methyl methacrylate and butyl methacrylate (Acryperl 200), 2.00% by weight ethylene glycol dimethacrylate, 0.70% by weight methyl hydroxyethyl paratoluidine, 0.30% by weight paraffin (softening point 46-48° C.), 0.30% by weight paraffin (softening point 52-54° C.), 0.20% by weight paraffin (63-66° C.), 0.50% by weight co-stabiliser (Alkanox 240), 0.06% by weight 2,6 di-tert. butyl-4-methyl phenol, 30.00% by weight hydroxyethyl methacrylate, 0.30% by weight methacryloyl oxyethyl phosphate and 0.50% by weight defoamer (BYK 052).

The viscosity of this acrylate resin was 402 mPa/s at D=1,000 l/s and 381 mPa/s at D=100 l/s.

### EXAMPLE 8

5 kg (meth)acrylate resin were prepared by mixing the following components: 40.64% by weight methyl methacrylate, 24.50% by weight copolymer of methyl methacrylate and ethyl acrylate (Diakon LG 156), 2.00% by weight ethylene glycol dimethacrylate, 0.70% by weight methyl hydroxyethyl paratoluidine, 0.30% by weight paraffin (softening point 46-48° C.), 0.30% by weight paraffin (softening point 52-54° C.), 0.20% by weight paraffin (softening point 63-66° C.), 0.50% by weight co-stabiliser (Alkanox 240), 0.06% by weight 2,6 di-tert. butyl-4-methyl phenol, 30.00% by weight hydroxyethyl methacrylate, 0.30% by weight methacryloyl oxyethyl phosphate and 0.50% by weight defoamer (BYK 052).

The viscosity of this acrylate resin was 522 mPa/s at D=1,000 l/s and 544 mPa/s at D=100 l/s.

### EXAMPLE 9

5 kg (meth)acrylate resin were prepared by mixing the following components: 55.14% by weight methyl methacrylate, 25.00% by weight copolymer of methyl methacrylate and ethyl acrylate (Diakon LG 156), 2.00% by weight ethyl glycol dimethacrylate, 0.70% by weight methyl hydroxyethyl paratoluidine, 0.30% by weight paraffin (softening point 46-48° C.), 0.30% by weight paraffin (softening point 52-54° C.), 0.20% by weight paraffin (softening point 63-66° C.), 0.50% by weight co-stabiliser (Alkanox 240), 0.06% by weight 2,6 di-tert. butyl-4-methyl phenol, 15.00% by weight hydroxyethyl methacrylate, 0.30% by weight methacryloyl oxyethyl phosphate and 0.50% by weight defoamer (BYK 052).

The viscosity of this acrylate resin was 348 mPa/s at D 1,000 l/s and 373 mPa/s at D 100 l/s.

### EXAMPLE 10

5 kg (meth)acrylate resin were prepared by mixing the following components: 41.14% by weight methyl methacrylate, 24.50% by weight copolymer of methyl methacrylate and ethyl acrylate (Diakon LG 156), 2.00% by weight ethylene glycol dimethacrylate, 0.70% by weight methyl hydroxyethyl paratoluidine, 0.30% by weight paraffin (softening point 46-48° C.), 0.30% by weight paraffin (softening point 52-54° C.), 0.20% by weight paraffin (softening point 63-66° C.), 0.50% by weight co-stabiliser (Alkanox 240), 0.06% by weight 2,6 di-tert. butyl-4-methyl phenol, 30.00% by weight hydroxyethyl methacrylate, 0.30% by weight methacryloyl oxyethyl phosphate.

The viscosity of this acrylate resin was 513 mPa/s at D=1,000 l/s and 535 mPa/s at D=100 l/s.

The four (meth)acrylate resins of Examples 7 to 10 described above were used to repair and/or seal sewer pipes and were each mixed with about 3% by weight benzoyl peroxide. The acrylate resins of Examples 7 to 10 were used to repair and/or seal pipes against pressing water and tested accordingly. For this purpose, a glass fibre mat impregnated with the resin concerned is inserted into a stoneware T-junction pipe via a “packer” in such a way that it is arranged centrally beneath the T-junction of the pipe, which extends vertically upwards, and projects about 15 cm over the side portions of the T-junction pipe. Before the packer is moved to the correct position, and while this is being done, water is constantly poured into the branch, which can be done, for example, by means of a garden hose or simply with a bucket. Also while the packer is being inflated, water is topped up at about 0.1 litres per second. During the curing time, water remains in the junction right up to the top rim. After the packer has been removed, an observer watches whether the water column is maintained or whether water drips down through the glass fibre mat or runs out between the glass fibre mat and the stoneware wall. The pieces of pipe thus sealed were likewise subjected to a leak test in accordance with DIN EN 1610. For the resins of Examples 7 to 9, no water penetration was found after the packer was removed. For Example 10, water penetration was found immediately after removal of the packer. The results of the pressure losses determined for Examples 7 to 10 are shown in the following Table 2.

TABLE 2

| | Pressure loss |
|---|---|
| Example | [mbar] |
| 7 | 2.5 |
| 8 | 3 |
| 9 | 0 |
| 10 | 80 |

As is apparent from Table 2, the (meth)acrylate resins which were prepared in accordance with Examples 7-9 are also very suitable for repairing and/or sealing pipes against pressing water. Example 10 shows, however, that it is not possible to seal the pipes satisfactorily against pressing water without the defoamer, so that when used to repair and/or seal pipes against pressing water, the use of the defoamer is a precondition for a satisfactory result.

Having now described preferred embodiments of the invention, in both the Summary of the Invention and Detailed Description of Preferred Embodiments sections, variations that do not depart from the spirit of the invention may occur to those skilled in the art. The invention is thus not limited to the preceding description but is instead set forth in the appended claims and legal equivalents thereof.

1. A (meth)acrylate resin comprising:

| | |
|---|---|
| 20-85% by weight | (meth)acrylate |
| 10-40% by weight | of a polymer soluble in (meth)acrylate |
| 0.1-2% by weight | paraffin |
| 0-50% by weight | hydroxy(meth)acrylate |
| 0.1-2% by weight | adhesion promoter. |

2. The (meth)acrylate resin as claimed in claim 1, comprising:

| | |
|---|---|
| 30-40% by weight | (meth)acrylate |
| 25-35% by weight | of a polymer soluble in (meth)acrylate |
| 0.5-1% by weight | paraffin |
| 5-40% by weight | hydroxy(meth)acrylate |
| 0.2-1.0% by weight | adhesion promoter. |

3. The (meth)acrylate resin as claimed in claim 1, characterised in that the (meth)acrylate is methyl methacrylate.

4. The (meth)acrylate resin as claimed in claim 1, characterised in that the polymer soluble in (meth)acrylate comprises a (meth)acrylate homopolymer and/or a copolymer.

5. The (meth)acrylate resin as claimed in claim 4, characterised in that the homopolymer is polymethyl methacrylate.

6. The (meth)acrylate resin as claimed in claim 4, characterised in that the copolymer is a copolymer of methyl methacrylate and butyl methacrylate, methyl methacrylate and ethyl acrylate or vinyl chloride and vinyl acetate.

7. The (meth)acrylate resin as claimed in claim 5, characterised in that the copolymer is a copolymer of methyl methacrylate and butyl methacrylate, methyl methacrylate and ethyl acrylate or vinyl chloride and vinyl acetate.

8. The (meth)acrylate resin as claimed in claim 1, characterised in that the hydroxy(meth)acrylate is hydroxyethyl methacrylate.

9. The (meth)acrylate resin as claimed in claim 1, characterised in that the (meth)acrylate resin further contains 1-10% by weight cross-linking agent, preferably 1-3% by weight.

10. The (meth)acrylate resin as claimed in claim 9, characterised in that the cross-linking agent is ethylene glycol dimethacrylate, 1,4 butanediol dimethacrylate and/or tri-ethylene glycol dimethacrylate.

11. The (meth)acrylate resin as claimed in claim 1, characterised in that the (meth)acrylate resin further comprises 0.1 to 2% by weight defoamer, preferably 0.1-1.0% by weight (based on the (meth)acrylate resin).

12. The (meth)acrylate resin as claimed in claim 1, characterised in that the (meth)acrylate resin comprises further conventional additives, such as 0.1-2% by weight co-stabiliser and/or 0.01-0.1% by weight stabiliser.

13. The (meth)acrylate resin as claimed in claim 12, characterised in that the (meth)acrylate resin comprises 0.02 to 0.07% by weight stabiliser and/or 0.5-1.0% by weight co-stabiliser.

14. The (meth)acrylate resin as claimed in claim 12, characterised in that the stabiliser is 2,6 di-tert butyl-4-methyl phenol and the co-stabiliser is tri-(2,4 di-tert. butyl phenyl)phosphite.

15. The (meth)acrylate resin as claimed in claim 13, characterised in that the stabiliser is 2,6 di-tert butyl-4-methyl phenol and the co-stabiliser is tri-(2,4 di-tert. butyl phenyl)phosphite.

16. The (meth)acrylate resin as claimed in claim 1, characterised in that the (meth)acrylate resin further comprises 0.1-1.5% by weight, preferably 0.4-0.8% by weight, accelerator and 0.1-5% by weight, preferably 2-4% by weight initiator.

17. The (meth)acrylate resin as claimed in claim 16, characterised in that the accelerator is methyl hydroxyethyl paratoluidine, dimethyl paratoluidine, dihydroxyethyl paratoluidine or dihydroxypropyl paratoluidine and/or that the initiator is benzoyl peroxide.

18. The (meth)acrylate resin as claimed in claim 1, characterised in that the paraffin comprises a mixture of different paraffins with different softening points, especially paraffins with a softening point between 46 and 48° C., paraffins with a softening point between 52 and 54° C. and paraffins with a softening point between 63 and 66° C.

19. The (meth)acrylate resin as claimed in claim 1, characterised in that the adhesion promoter is a phosphoric ester, especially methacryloyl oxyethyl phosphate.

20. The (meth)acrylate resin as claimed in claim 1, characterised in that the viscosity of the (meth)acrylate resin before curing is at least 250 mPa/s at D=1,000 l/s or at least 300 mPa/s at D=100 l/s.

21. The (meth)acrylate resin as claimed in claim 1, characterised in that colorants, such as colour pigments or a dye paste, are also added to the (meth)acrylate resin.

22. A method of repairing a pipe utilizing the (meth)acrylate resin of claim 1 wherein the method comprises applying the resin to the pipe to seal an opening.

23. The method of claim 22, characterised in that the pipe comprises material from one of the group consisting of stoneware, concrete and plastic.

24. The method of claim 22 wherein the pipe is a sewer pipe.

25. The method of claim 23 wherein the pipe comprises polyvinyl chloride.
